(19) United States
(12) Patent Application Publication
(10) Pub. No.: US 2026/0313661 A1
(43) Pub. Date: Oct. 8, 2026

(54) PTRS DESIGN FOR SINGLE DCI SIMULTANEOUS PUSCH TRANSMISSION WITH SDM OR SFN

(71) Applicant: Apple Inc., Cupertino, CA (US)

(72) Inventors: Haitong SUN, Saratoga, CA (US); Dan WU, Beijing (CN); Dawei ZHANG, Saratoga, CA (US); Wei ZENG, Saratoga, CA (US); Seyed Ali Akbar FAKOORIAN, San Diego, CA (US); Xiang CHEN, Palo Alto, CA (US); Ankit BHAMRI, Haar (DE)

(21) Appl. No.: 19/482,698

(22) PCT Filed: May 11, 2023
(86) PCT No.: PCT/CN2023/093600

§ 371 Date: Nov. 7, 2025

(51) Int. Cl. H04W 72/232; H04L 5/00; H04W 72/21

(52) U.S. Cl. CPC H04W 72/232; H04L 5/0051; H04W 72/21

(57) ABSTRACT

In one aspect, abase station, includes a transceiver configured to communicate with a user equipment (UE). The base station also includes a processor communicatively coupled to the transceiver and configured to perform operations including transmitting, by the network, a downlink control information (DCI) signal to the UE, the DCI comprising an indication associated with UE operation under simultaneous transmission across multiple panels (STxMP) with single frequency network (SFN) or with spatial division multiplexing (SDM), and communicating with the UE based on a maximum number of layers associated with the indication.

### FIELD OF INVENTION

This disclosure relates generally to wireless technology and more particularly to phase tracking reference signal (PTRS) design for single downlink control information (DCI) simultaneous physical uplink shared channel (PUSCH) transmission with spatial division multiplexing (SDM) or single frequency network (SFN).

### BACKGROUND

Fifth generation mobile network (5G) is a wireless standard that aims to improve upon data transmission speed, reliability, availability, and more. The wireless standard includes numerous procedures that may be implemented by a transmitting device or a receiving device that improves the latency, the speed, and the reliability of uplink and downlink transmissions.

### SUMMARY

Aspects of the present disclosure relate to 5G new radio (NR) operating in the licensed spectrum or in the shared and unlicensed spectrum (NR-U).

In an aspect of the present disclosure, a method, performed by a network coupled to a user equipment (UE), comprises transmitting, by the network, a downlink control information (DCI) signal to the UE, the DCI comprising an indication associated with UE operation under simultaneous transmission across multiple panels (STxMP) with spatial division multiplexing (SDM); and communicating with the UE based on a maximum number of layers associated with the indication.

In an aspect, a method, performed by user equipment (UE) that is coupled to a network, comprises receiving, by the UE, a downlink control information (DCI) signal from the network, the DCI comprising an indication associated with UE operation under simultaneous transmission across multiple panels (STxMP) with spatial division multiplexing (SDM); and communicating with the network based on a maximum number of layers associated with the indication.

In an aspect, a method, performed by a network coupled to a user equipment (UE), comprises transmitting, by the network, a downlink control information (DCI) signal to the UE, the DCI comprising an indication associated with UE operation under simultaneous transmission across multiple panels (STxMP) with single frequency network (SFN); and communicating with the UE based on a maximum number of layers associated with the indication.

In an aspect, a method, performed by user equipment (UE) that is coupled to a network, comprises receiving, by the UE, a downlink control information (DCI) signal from the network, the DCI comprising an indication associated with UE operation under simultaneous transmission across multiple panels (STxMP) with single frequency network (SFN); and communicating with the network based on a maximum number of layers associated with the indication.

In an aspect, a base station comprises a transceiver configured to communicate with a user equipment (UE), and a processor communicatively coupled to the transceiver and configured to perform the methods described herein from the perspective of the network.

In an aspect, a processor (e.g., a baseband processor) of a UE is configured to perform the methods described herein from the perspective of the UE.

Other technical features may be readily apparent to one skilled in the art from the following figures, descriptions, and claims.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example wireless communication system according to some aspects.

FIG. 2 illustrates uplink and downlink communications according to some aspects.

FIG. 3 illustrates an example block diagram of a UE according to some aspects.

FIG. 4 illustrates an example block diagram of a BS according to some aspects.

FIG. 5 illustrates an example block diagram of cellular communication circuitry, according to some aspects.

FIG. 6 shows an example of a UE with simultaneous transmission of PUSCH with multiple panels, in accordance with an aspect.

FIG. 7 shows an example of configuration for uplink phase tracking reference signal (UL PTRS), in accordance with an aspect

FIG. 8 shows an example diagram illustrating dynamic switching between SDM STxMP and sTRP, in accordance with some embodiments.

FIG. 9 shows an example diagram illustrating dynamic switching between SFN STxMP and sTRP, in accordance with some embodiments.

### DETAILED DESCRIPTION

A method and apparatus for performing operations between a user equipment (UE) and a network are described. In the following description, numerous specific details are set forth to provide thorough explanation of aspects of the present invention. It will be apparent, however, to one skilled in the art, that aspects of the present invention may be practiced without these specific details. In other instances, well-known components, structures, and techniques have not been shown in detail in order not to obscure the understanding of this description.

Reference in the specification to “some aspects” or “an aspect” means that a particular feature, structure, or characteristic described in connection with the aspect can be included in at least one aspect of the invention. The appearances of the phrase “in some aspects” in various places in the specification do not necessarily all refer to the same aspect.

In the following description and claims, the terms “coupled” and “connected,” along with their derivatives, may be used. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

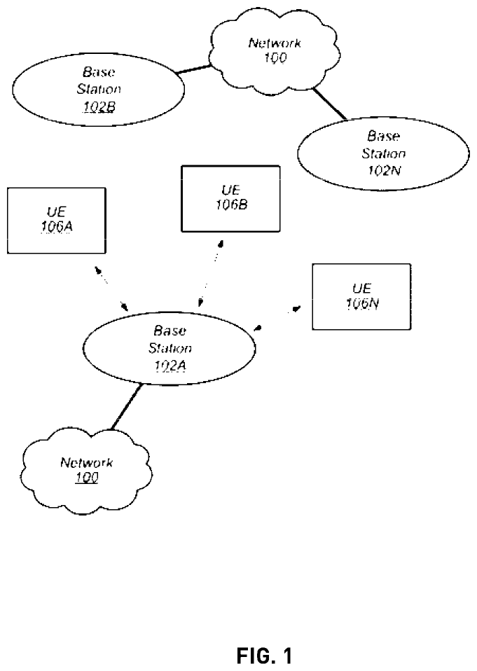

FIG. 1 illustrates a simplified example wireless communication system, according to some aspects. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to as a “user equipment” (UE).

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some aspects, base station 102A may be a next generation base station, e.g., a 5G New Radio (5G NR) base station, or “gNB”. In some aspects, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

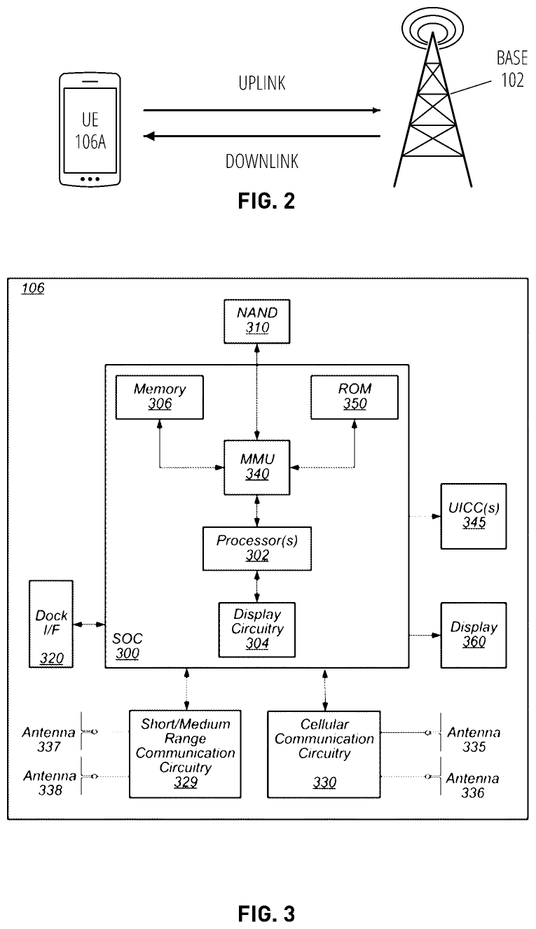

FIG. 2 illustrates UE 106A that can be in communication with a base station 102 through uplink and downlink communications, according to some aspects. The UEs may each be a device with cellular communication capability such as a mobile phone, a hand-held device, a computer or a tablet, or virtually any type of wireless device.

The UE may include a processor that is configured to execute program instructions stored in memory. The UE may perform any of the method aspects described herein by executing such stored instructions. Alternatively, or in addition, the UE may include a programmable hardware element such as an FPGA (field-programmable gate array) that is configured to perform any of the method aspects described herein, or any portion of any of the method aspects described herein.

The UE may include one or more antennas for communicating using one or more wireless communication protocols or technologies. In some aspects, the UE may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE may include separate transmit and/or receive chains (e.g., including separate antennas and other radio components) for each wireless communication protocol with which it is configured to communicate. As a further possibility, the UE may include one or more radios which are shared between multiple wireless communication protocols, and one or more radios which are used exclusively by a single wireless communication protocol. For example, the UE might include a shared radio for communicating using either of LTE or 5G NR (or LTE or 1×RTT or LTE or GSM), and separate radios for communicating using each of Wi-Fi and Bluetooth. Other configurations are also possible.

FIG. 3 illustrates an example simplified block diagram of a communication device 106, according to some aspects. It is noted that the block diagram of the communication device of FIG. 3 is only one example of a possible communication device. According to aspects, communication device 106 may be a UE device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some aspects, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some aspects, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

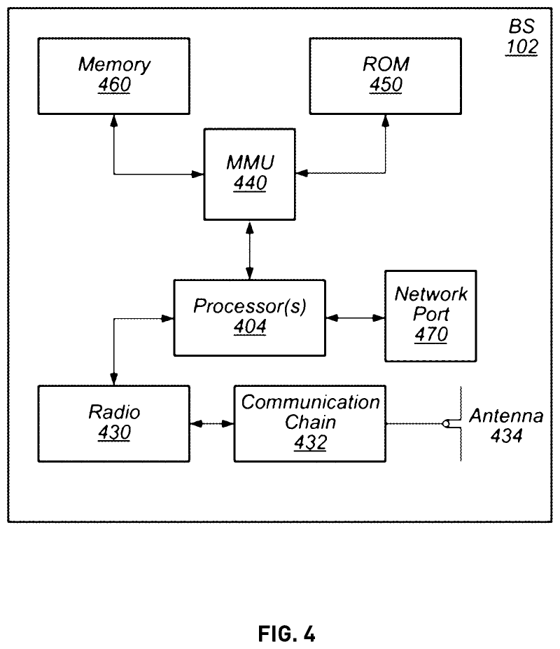

FIG. 4 illustrates an example block diagram of a base station 102, according to some aspects. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, e.g., a 5G New Radio (5G NR) base station, or “gNB”. In such aspects, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs. In some aspects, the base station can operate in 5G NR-U mode.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, 5G NR-U, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR and 5G NR-U. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

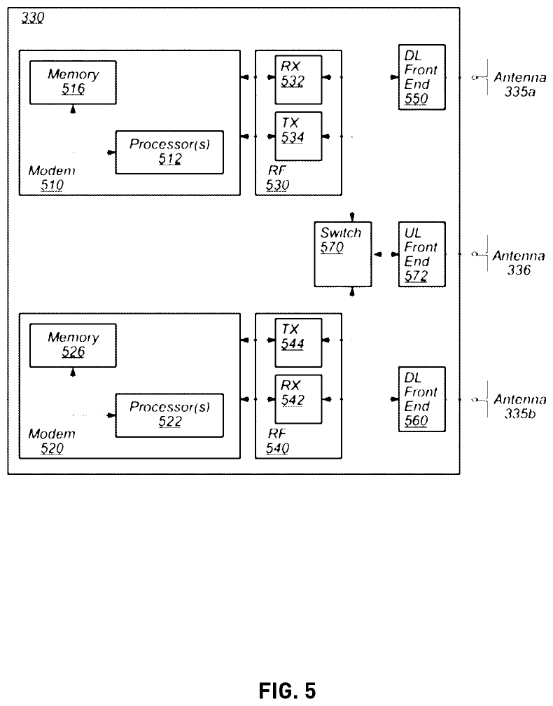

FIG. 5 illustrates an example simplified block diagram of cellular communication circuitry, according to some aspects. It is noted that the block diagram of the cellular communication circuitry of FIG. 5 is only one example of a possible cellular communication circuit. According to aspects, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some aspects, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some aspects, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some aspects, receive circuitry 542 may be in communication with DL front end 560, which may include circuitry for receiving radio signals via antenna 335b.

In some aspects, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for determining a physical downlink shared channel scheduling resource for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for determining a physical downlink shared channel scheduling resource for a user equipment device and a base station, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

5G supports multi-antenna transmission, beam-forming, and simultaneous transmission from multiple geographically separates sites. Channels of different antenna ports that are relevant for a UE may differ, for example, in terms of radio channel properties. QCL antenna port may be geographically separated.

5G physical channels provide flexible communication between the 5G base stations and the UEs. 5G NR has specified the physical channels for 5G networks that can be used either for Downlink or Uplink communication. 5G NR physical channels used for uplink communication includes the physical uplink shared channel (PUSCH), the physical uplink control channel (PUCCH), and the physical random-access channel (PRACH). Uplink signals such as demodulation reference signal (DMRS), phase tracking reference signal (PTRS), and sounding reference signal (SRS) are also supported. 5G NR supports the simultaneous transmission on PUSCH and PUCCH. PUSCH is typically used to carry the user data and optionally, can carry uplink control information (UCI).

PDSCH stands for Physical Downlink Shared Channel and is a channel used to deliver data from the base station (e.g., eNodeB) to the user equipment (UE) in the downlink direction. PDSCH supports high data rates and low latency for a wide range of applications and services. It uses advanced modulation and coding schemes, as well as multiple antenna techniques such as MIMO (Multiple Input Multiple Output), to maximize spectral efficiency and improve the overall performance of the network. PDSCH is also used in conjunction with other channels, such as the Physical Downlink Control Channel (PDCCH) and Physical Hybrid ARQ Indicator Channel (PHICH), to support features such as channel state information reporting, scheduling and retransmission of data packets, and HARQ (Hybrid Automatic Repeat Request) feedback. PDSCH enables the delivery of high-speed data and low-latency services to users in the downlink direction, and supports a range of advanced features and capabilities that promote efficient and reliable operation of the network.

Multiple Input Multiple Output (MIMO) may be used in 5G networks to increase data rates, improve spectral efficiency, and enhance the reliability of wireless communications. Under MIMO operation, multiple antennas are used at both the transmitter (e.g., the base station) and receiver (user equipment or UE) to transmit and receive multiple data streams simultaneously. MIMO can be used in both the uplink and downlink directions, and can support a range of antenna configurations, including 2×2, 4×4, 8×8, or higher. The number of antennas used in a MIMO configuration may be expressed by two numbers, where the first number represents the number of antennas at the transmitter (e.g., the base station), and the second number represents the number of antennas at the receiver (e.g., the UE). MIMO supports high data rates and low latency by allowing multiple data streams to be transmitted and received simultaneously, even in environments with high levels of interference or signal attenuation. Each data stream may be referred to as a layer.

Demodulation Reference Signal (DMRS) is specific for each UE, and may be used to estimate the radio channel. The network or UE can beamform the DMRS, keep it within a scheduled resource, and transmit it only when necessary in either DL or UL. Additionally, multiple orthogonal DMRSs can be allocated to support MIMO transmission.

A Phase Tracking Reference Signal (PTRS) is useful because the phase noise of a transmitter tends to increase as the frequency of operation increases. The PTRS may minimize the effect of the oscillator phase noise on system performance. Phase noise may introduces a phase rotation of the sub-carriers, which may be referred to as common phase error (CPE), into OFDM symbols. PTRS may be used to track phase of the Local Oscillator at transmitter and receiver and suppress phase noise and common phase error specially at higher mmwave frequencies. PTRS is present both in uplink (in NR-PUSCH) and downlink (in NR-PDSCH) channels. PTRS may be associated with one DMRS port during transmission.

Sounding Reference Signal (SRS) is a UL signal transmitted by the UE to help the network obtain the channel state information (CSI) for each UE. Channel State Information describes how a NR signal propagates from the UE to the gNB and represents the combined effect of scattering, fading, and power decay with distance. The UE transmits the SRS, which is a predefined signal with known characteristics, at a specific time and frequency. The SRS configuration is provided to the UE by the gNB, and it may vary depending on the cell's conditions and traffic requirements. The UE sends the SRS periodically or aperiodically, as instructed by the gNB, on the uplink (UL) channel. For example, the network may configure the UE with one or more SRS resource sets through a higher layer parameter which may be referred to as an SRS-ResourceSet. Each SRS resource set may contain up to 16 SRS resources. UE can be configured to send SRS on 1/2/4 antenna ports. SRS can be configured to use 1/2/4 symbols in time domain, these symbols are located in last 6 symbols of the slot. Antenna ports can be identified as 1000, 1001,1002,1003.

New Radio (NR) uplink (UL) supports two multi-input multi-output (MIMO) operation modes, such as codebook and non-codebook. Further, NR UL may support up to four layers, but not more. A layer may be understood as a separate data stream.

A codebook refers to a set of predefined beamforming vectors that are used by the base station to steer the antenna radiation pattern towards a particular user or group of users. The codebook may include a look-up table that the base station uses to select the best beamforming vector for a given user or group of users, based on channel conditions and other factors. The codebook may include multiple sets of beamforming vectors optimized for different scenarios, such as indoor versus outdoor environments, line-of-sight versus non-line-of-sight conditions, and so on. Codebook may include a matrix having complex value elements that transforms a data bit (e.g., in PDSCH) to another set of data that maps to each antenna port. By selecting the optimal beamforming vector for each user or group of users, the base station can minimize interference and maximize signal strength, leading to faster and more reliable connections.

Under codebook based UL, such as when sounding reference signal (SRS) resource set usage is set to “codebook”, the UE may transmit SRS resource with multiple ports. The network (NW) may schedule PUSCH by indicating the TPMI (transmit precoding matrix) and SRS rank indication (SRI).

Under a non-Codebook based UL, such as when SRS resource set usage=“nonCodebook”, the UE may transmit multiple SRS signals, each with a single port. The NW may schedule PUSCH by indicating the SRS resource/port selection and SRI.

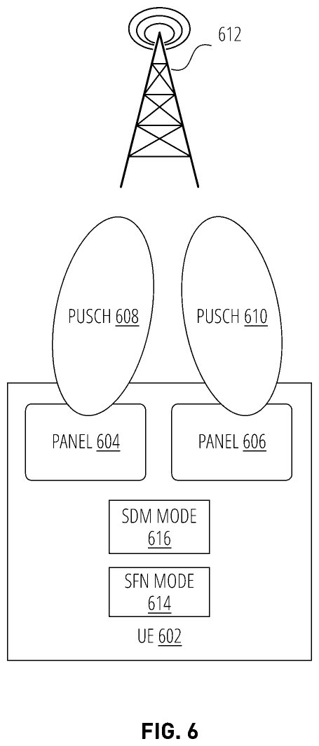

FIG. 6 shows an example of a UE with simultaneous transmission of PUSCH with multiple panels, in accordance with an aspect. 5G and MIMO evolution may support two modes of single DCI based simultaneous transmission of PUSCH from multiple panels. A UE 602 may have two panels 604 and 606. Each panel 604 and 606 may point in a respective direction that is different than the other panel. A panel may also be referred to as a panel antenna, which is a directional antenna that is configured to send and receive radio signals from a single direction and not others. A panel antenna has a wider beam compared to other directional antenna, which allows each panel antenna to cover a larger area.

When the UE 602 communicates the two PUSCHs (608 and 610) simultaneously, this may be referred to as simultaneous transmission across multiple panels (STxMP). STxMP may operate in two modes. A first mode may be referred to as SDM (spatial division multiplexing) mode 616 (or SDM STxMP). A second mode may be referred to as SFN (single frequency network) mode 614 (or SFN STxMP). In each mode, the UE 602 may perform operations that are specific to that mode, as described in further detail in other sections, to operate each panel 604 and panel 606 to transmit a respective PUSCH.

For example, panel 604 may be operated to transmit data through an uplink channel PUSCH 608 and panel 606 may be operated to transmit data through an uplink channel PUSCH 610 to base station 612. The PUSCHs may be transmitted separately and simultaneously by the UE to the base station 612. The UE 602 may also operate under a non-STxMP mode, such as single transmission and reception point (sTRP) mode, where the UE uses only one of the panels 604 or 606 to send a single PUSCH.

For single DCI simultaneous PUSCH transmission, 5G may support dynamic switching between SDM (or SFN) scheme of single-DCI based STxMP (simultaneous transmission across multiple panels) PUSCH and sTRP transmission, however, it is not clear or agreed upon as to how the network may provide the indication to dynamically switch between sTRP and SDM STxMP (or SFN STxMP), nor is it clear or agreed upon as to what the maximum number of layers should be when switching to sTRP transmission. Dynamic switching may include a downlink signal (e.g., DCI) from the network to the UE to signal a change in behavior.

For single DCI simultaneous PUSCH transmission, 5G may support independent configuration of the maximal number of layers for sTRP and SDM STxMP mode (or SFN STxMP), but details have yet to be determined.

Aspects of the present disclosure address PTRS design for single DCI simultaneous PUSCH transmission with SDM or SFN. Various PTRS design issues may be addressed in this context. Some aspects relate to PTRS port configuration. Some aspects relate to PTRS-DMRS association indication. Some aspects relate to shared ports between SDM/SFN and sTRP.

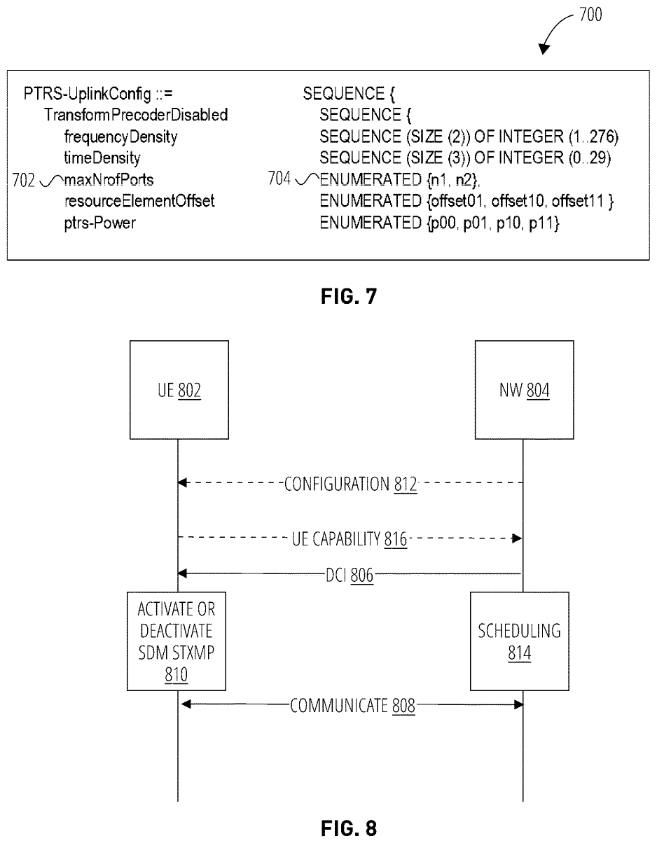

FIG. 7 shows an example of configuration for uplink phase tracking reference signal (UL PTRS), in accordance with an aspect. PTRS port configuration may be performed through configuration of the uplink phase tracking reference signal (UL PTRS). The network may configure UL PTRS of the UE through signaling (e.g., RRC signaling). A network may transmit signaling to the UE containing PTRS-Uplink Config 700 which may include various fields. For example, PTRS-Uplink Config 700 may include a field 702 that indicates a maximum number of ports “maxNrofPorts”. This field may comprise an enumerated value of ‘n1’ or ‘n2’.

It should be understood that the aspects described in the present disclosure are not exclusive of each other and may be combined with each other unless logically incompatible as understood by one skilled in the art.

FIG. 8 shows an example diagram illustrating dynamic switching between SDM STxMP and sTRP, in accordance with some embodiments.

At operation 806, the network (NW) 804 may transmit a DCI signal to the UE. The DCI may comprise an indication associated with UE operation under simultaneous transmission across multiple panels (STxMP) with spatial division multiplexing (SDM) in what may be referred to as SDM STxMP. For example, the DCI signal may include a field that indicates to the UE 802 to change from sTRP to SDM STxMP operation, or to change from SDM STxMP to sTRP operation.

At operation 810, in response to the indication received from the network, UE 802 may dynamically activate or deactivate SDM STxMP, depending on the field value of the indication received through operation 806.

At operation 808, the network 804 may communicate with the UE 802 based on a maximum number of layers associated with the indication. For example, if the UE 802 is toggled to operate in sTRP mode, the network 804 and UE 802 may assume a maximum number under one or more first rules, and if the UE 802 is toggled to operate in SDM STxMP mode, the UE 802 and network 804 may assume a maximum number of layers under one or more second rules. Details are described below. The maximum number of layers may be understood as a maximum number of data streams that may be communicated over MIMO communications between the UE and network (e.g., during uplink communications). Communication at operation 808 may include the UE 802 using two panels (e.g., when SDM STxMP is activated), and using a single panel (e.g., when SDM STxMP is deactivated).

Configuration operation 812 may include one or more signals from NW 804 to UE 802 to configure one or more settings of the UE (e.g., UL PTRS, or other settings). Configuration operation 812 may include RRC signaling, a higher layer signaling, or other signaling. Configuration operation 812 may occur in time as shown in the example, but may also be provided from the NW to the UE at other times.

In one aspect, when the NW configures the UE with a single DCI based SDM STxMP operation, for the maximum number of PUSCH layers configuration, the following restriction may apply regarding the maximum number of layers: In a first option, The maximum number of layers L_(max,sTRP)=2*L_(max,SDM). In a second option, the maximum number of layers L_(max,sTRP)=L_(max,SDM). In a third option, the maximum number of layers L_(max,sTRP)≤2*L_(max,SDM). In a fourth option, the maximum number of layers L_(max,sTRP)≥L_(max,SDM).

L_(max,sTRP) may refer to the maximum number of layers for sTRP transmission. L_(max,SDM) may refer to maximal number of layers that is applied to each SRS resource set (panel/TRP) separately. These may be configured through operation 912, or assumed by UE 902 and NW 904, as described.

For example, the indication received in the DCI (through operation 806) may comprise an instruction to transition from STxMP (e.g., SDM STxMP) to single transmission and reception point (sTRP). The maximum number of layers associated with the indication comprises a maximum number of layers associated with the sTRP that is equal to or less than with twice a maximum number of layers associated with each individual panel for STxMP. In this, and in other embodiments, the maximum number of layers may be set by signaling (e.g., through field 702 of PTRS-UplinkConfig 700) which may be performed at operation 812. Thus, at operation 810, the UE will transition from SDM STxMP to sTRP and operate with the maximum number of layers being equal to or less than twice a maximum number of layers associated with each individual panel for STxMP.

In another example, the indication comprises an instruction to transition from STxMP (e.g., SDM STxMP) to single transmission and reception point (sTRP). The maximum number of layers associated with the indication comprises a maximum number of layers associated with the sTRP that is equal to a maximum number of layers associated with each individual panel for STxMP.

In one aspect, when the NW 804 configures the UE 802 with single DCI based SDM STxMP operation (e.g., at operation 806), the NW can freely configure the UE with the number of ports for UL PTRS, such as, for example, maxNrofPorts in PTRS-UplinkConfig can be either “n1” or “n2”. For example, the network may configure the UE (e.g., at operation 812) with a maximum number of ports for uplink phase tracking reference signal (PTRS) that is set to either n1 or n2 in PTRS-uplink configuration, without restriction.

In one aspect, when NW 802 configures the UE 804 with single DCI based SDM STxMP operation (e.g., at operation 806), the NW may configure two port PTRS, such as, for example, maxNrofPorts in PTRS-UplinkConfig is set to “n2”. The configuration of the two port PTRS may be done through signaling operation 812.

In one aspect, when NW 804 configures the UE 802 with single DCI based SDM STxMP operation (e.g., at operation 806), and NW configures two port UL PTRS (e.g., at operation 812), when dynamic switching between SDM and sTRP is configured, and when gNB schedules sTRP, in terms of the number of ports for UL PTRS, one option is that only single port is assumed by the UE 802 and NW 804. For example, when dynamic switching between SDM and single transmission and reception point (sTRP) is configured, and when the network schedules the sTRP, the network operates under an assumption that only a single port (or single layer) is used for uplink (UL) PTRS. Another option is that 2 port PTRS is assumed. For example, when dynamic switching between SDM and single transmission and reception point (sTRP) is configured, and when the network schedules the sTRP, the network operates under an assumption that two ports (or layers) are used for uplink (UL) PTRS.

In one aspect (1.5), when the network configures the UE with two port uplink (UL) PTRS (e.g., through operation 812), and when dynamic switching between SDM and single transmission and reception point (sTRP) is configured (e.g., through operation 812), and when the network schedules the sTRP (e.g., at operation 814), the network assumes one port (or layer) UL PTRS in response to at least one of: i) the network (e.g., gNB) configures full-coherent physical uplink shared channel (PUSCH) operation for sTRP, or ii) the network configures non-coherent PUSCH operation for sTRP with a single port, wherein for codebook operation, the number of ports (or layers) to be used by the UE is the number of sounding reference signal (SRS) port for SRS-Resource in SRS-ResourceSet with usage set to codebook. For non-codebook, the number of ports (or layers) to be used by the UE is equal to a number of SRS-Resource in the SRS-ResourceSet with usage set to ‘nonCodebook’ (e.g., through operation 812). The number of ports to be used by the UE may also be referred to as a maximum number of ports to be used by the UE during the respective mode (e.g., SDM STxMP or sTRP).

In one aspect, when the NW 804 configures the UE 802 with two port uplink (UL) PTRS (e.g., through operation 812), and when dynamic switching between SDM and single transmission and reception point (sTRP) is configured, and when the network schedules the sTRP, the network assumes two port UL PTRS in response to at least one of: i) the network configures partial-coherent physical uplink shared channel (PUSCH) operation for sTRP; or ii) the network configures non-coherent PUSCH operation for sTRP with more than one port, wherein for codebook operation, the number of ports (or layers) to be used by the UE is equal to a number of sounding reference signal (SRS) ports for SRS-Resource in SRS-ResourceSet with usage set to codebook. For non-codebook operation, the number of ports (or layers) to be used by the UE is equal to a number of SRS-Resource in the SRS-ResourceSet with usage set to ‘nonCodebook’.

A PTRS-DMRS association may be a field in DCI signaling (e.g., through operation 806). The field may be 0 or 2 bits, depending on other factors, such as if UL PTRS and/or PUSCH are configured through RRC (e.g., through operation 812). The network 804 and UE 802 may agree on the conditions that define what the bitwidth should be. The NW 804 may send the PTRS-DMRS association to the UE 802 through DCI operation 806.

In one aspect, the NW 804 configures the UE 802 with single DCI based SDM STxMP operation (e.g., at operation 806), in DCI format 0_1 and 0_2, the bitwidth of “PTRS-DMRS association” is 0 under any of the following conditions: PTRS-UplinkConfig is not configured and transform precoder is disabled; transform precoder is enabled; L_(max,SDM)=1 and dynamic switching between SDM STxMP and sTRP is not configured; L_(max,SDM)=1 and L_(max,sTRP)=1 and dynamic switching between SDM STxMP and sTRP is configured.

For example, the network sets a bitwidth of a phase tracking reference signal demodulation reference signal association (PTRS-DMRS association) to zero when a DCI format of the DCI is 0_1 or 0_2, in response to one or more of the following first conditions: PTRS-uplink configuration is not configured and transform precoder is disabled, transform precoder is enabled, a maximum number of layers for SDM is one and dynamic switching between SDM STxMP and sTRP is not configured, or a maximum number of layers for SDM and sTRP are equal to one and dynamic switching between SDM STxMP and sTRP is configured. This may be referred to as a first scenario.

Table 7.3.1.1.2-25 and 7.3.1.1.2-26 (shown below) of 3GPP TS 38.212 version 15.3.0 are used to indicate the association between PTRS port(s) and DMRS port(s) for transmission of one PTRS port and two PTRS ports respectively, and the DMRS ports are indicated by the Antenna ports field. It has been agreed that for the PTRS-DMRS association field, the number of bits (e.g., zero or two) is determined as follows—0 bit if PTRS-UplinkConfig is not configured and transform precoder is disabled, or if transform precoder is enabled, or if maxRank=1; −2 bits otherwise.

Table 1 below is an example of 7.3.1.1.2-25 of 3GPP TS 38.212 version 15.3.0.

| Value | DMRS port |
|---|---|
| 0 | 1st scheduled DMRS port |
| 1 | 2nd scheduled DMRS port |
| 2 | 3rd scheduled DMRS port |
| 3 | 4th scheduled DMRS port |

Table 2 below is an example of 7.3.1.1.2-26 of 3GPP TS 38.212 version 15.3.0, which allows for four configurations. A PTRS-DMRS association of ‘00’ may mean that the 1st DMRS port shares PTRS port 0 and the 1st DMRS port shares PTRS port 1. Similarly, a PTRS-DMRS association of ‘01’ may mean that the 1st DMRS port shares PTRS port 0 and the 2nd DMRS port shares PTRS port 1, and so on.

| Value | | Value | |
|---|---|---|---|
| of MSB | DMRS port | of LSB | DMRS port |
| 0 | 1st DMRS port which | 0 | 1st DMRS port which |
| | shares PTRS port 0 | | shares PTRS port 1 |
| 1 | 2nd DMRS port which | 1 | 2nd DMRS port which |
| | shares PTRS port 0 | | shares PTRS port 1 |

In one aspect, when the NW 804 configures the UE 802 with single DCI based SDM STxMP operation (at operation 806), in DCI format 0_1 and 0_2, the bitwidth of “PTRS-DMRS association” is 1 when PTRS-UplinkConfig is configured and transform precoder is disabled, and under any of the following condition: L_(max,SDM)=1 and L_(max,sTRP)=2 and coherent operation is configured for sTRP and dynamic switching between SDM STxMP and sTRP is configured.

For example, the network 804 sets the bitwidth of the PTRS-DMRS association to one when the DCI format of the DCI is 0_1 or 0_2 and when the PTRS-uplink configuration is configured and the transform precoder is disabled, and in response to a second condition which includes the maximum number of layers for SDM being equal to one, and the maximum number of layers for sTRP being equal to two, and the coherent operation being configured for sTRP and the dynamic switching between SDM STxMP and sTRP being configured. This may be referred to as a second scenario.

In one aspect, when the NW 804 configures the UE 802 with single DCI based SDM STxMP operation (at operation 806), in DCI format 0_1 and 0_2, the bitwidth of “PTRS-DMRS association” is two under the condition that: the conditions in scenario 1 are not present, or the conditions under scenario 1 and scenario 2 are not present.

For example, the network sets a bitwidth of the PTRS-DMRS association to two when the DCI format of the DCI is 0_1 or 0_2 in response to none of the first conditions (e.g., in scenario 1) being satisfied, or none of the first conditions and the second condition (in scenario 2) being satisfied.

In one aspect, when the NW 804 configures the UE 802 with single DCI based SDM STxMP operation (e.g., at operation 806), in DCI format 0_1 and 0_2, the bitwidth of “PTRS-DMRS association” is 2 and 2 port PTRS is configured, when SDM STxMP is scheduled, interpretation of “PTRS-DMRS association” field is as follows: i) PTRS port 0 is associated with the DMRS ports associated with the first SRS resource set in which case DMRS ports may be associated with the first TPMI or SRI; and/or ii) PTRS port 1 is associated with the DMRS ports associated with the second SRS resource set in which case DMRS ports may be associated with the second TPMI or SRI.

For example, when a DCI format of DCI is 0_1 or 0_2 (at operation 806), and when a bitwidth of PTRS-DMRS association is two, and when two port PTRS is configured, and when SDM STxMP is scheduled, the network associates a PTRS port zero with first DMRS ports that are associated with a first SRS resource set; and the network associates a PTRS port one with second DMRS ports that are associated a second SRS resource set. For further reference, Table 2 (above) includes mapping of PTRS-DMRS association.

In one aspect, when NW 804 configures the UE 802 with single DCI based SDM STxMP operation (e.g., at operation 806), in DCI format 0_1 and 0_2, the bitwidth of “PTRS-DMRS association” is 2 and 2 port PTRS is configured, if L_(max,SDM)=1, when SDM STxMP is scheduled. Under a first option, UE is not expected to be indicated “PTRS-DMRS association” other than “00”. Under a second option, regardless of what is indicated by “PTRS-DMRS association”, UE always assume “00”. For example, when a DCI format of DCI is 0_1 or 0_2, and when a bitwidth of PTRS-DMRS association is two, and when two port PTRS is configured, and when SDM STxMP is scheduled, in response to a maximum number of layers of SDM is equal to one, the network indicates PTRS-DMRS association as ‘00’, or the UE operates under an assumption that PTRS-DMRS association is equal to ‘00’.

In one aspect, when NW 804 configures the UE 802 with single DCI based SDM STxMP operation (e.g., at operation 806), in DCI format 0_1 and 0_2, the bitwidth of “PTRS-DMRS association” is 2 and 2 port PTRS is configured, when sTRP is scheduled, interpretation of “PTRS-DMRS association” field is the following: PTRS port 0 is associated with DMRS port associated with UL layers which are transmitted with PUSCH antenna port 1000 and PUSCH antenna port 1002; PTRS port 1 is associated with DMRS port associated with UL layers which are transmitted with PUSCH antenna port 1001 and PUSCH antenna port 1003. For example, when a DCI format of DCI is 0_1 or 0_2, and when a bitwidth of PTRS-DMRS association is two, and when two port PTRS is configured, and when sTRP is scheduled, the network associates PTRS port 0 with a first DMRS port that is associated with uplink (UL) layers which are transmitted with physical uplink shared channel (PUSCH) antenna port number 1000 and PUSCH antenna port number 1002, and the network associates PTRS port 1 with a second DMRS port that is associated with UL layers which are transmitted with PUSCH antenna port number 1001 and PUSCH antenna port number 1003. PTRS-DMRS association may be referenced in the tables provided above.

In one aspect, when NW 804 configures the UE 802 with single DCI based SDM STxMP operation (e.g., at operation 806), in DCI format 0_1 and 0_2, the bitwidth of “PTRS-DMRS association” is 2 and 2 port PTRS is configured, when sTRP is scheduled, and when coherent transmission is configured for sTRP: only single port PTRS is assumed; and/or the interpretation of the “PTRS-DMRS association” follows Table 1 above. For example, when a DCI format of DCI is 0_1 or 0_2, and when a bitwidth of PTRS-DMRS association is two, and when two port PTRS is configured, and when sTRP is scheduled, and when coherent transmission is configured for sTRP, the network operates under an assumption of single port PTRS operation, and PTRS-DMRS association for UL PTRS port zero is: zero for a first scheduled DMRS port, one for a second scheduled DMRS port, two for a third scheduled DMRS port, and three for a fourth scheduled DMRS port.

When UE 802 changes between SDM and sTRP operation (e.g., at operation 810), the UE 802 may share ports used between SDM operation and sTRP operation.

In an aspect, when the NW 804 configures the UE 802 with single DCI based SDM STxMP operation (e.g., at operation 806) and dynamic switching between SDM STxMP and SDM is configured (e.g., through RRC signaling 812), to allow shared ports between SDM and sTRP, i.e., a total number of used PUSCH antenna ports for the SDM and sTRP is the same, for codebook operation: Two SRS-ResourceSet are configured; SRS-Resource in each SRS-ResourceSet is configured with N ports, e.g., N=2,4; when gNB schedules SDM STxMP, only N/2 SRS ports in each SRS-Resource are used for PUSCH scheduling and/or when gNB schedules sTRP, all N SRS ports in each SRS-Resource are used for PUSCH scheduling. For example, when dynamic scheduling between SDM STxMP and sTRP is configured and two sounding reference signal (SRS)-ResourceSet are configured, under codebook operation: half of all SRS ports in each SRS-Resource in the SRS-ResourceSet when are used for PUSCH scheduling when STxMP is scheduled, and all of the SRS ports in each SRS-Resource in the SRS-ResourceSet are used for PUSCH scheduling when sTRP is scheduled.

In an aspect, when NW 804 configures the UE 802 with single DCI based SDM STxMP operation (e.g., at operation 806) and dynamic switching between SDM STxMP and SDM is configured, to allow shared ports between SDM and sTRP, i.e., total number of used PUSCH antenna ports for the SDM and sTRP is the same, for nonCodebook operation, the following may be understood between the NW 804 and the UE 802: Two SRS-ResourceSet are configured; N SRS-Resource are configured in each SRS-ResourceSet, e.g., N=2,4; when gNB schedules SDM STxMP, only N/2 SRS-Resource in each SRS-ResourceSet are used for PUSCH scheduling; and/or when gNB schedules sTRP, all N SRS-Resource in each SRS-ResourceSet are used for PUSCH scheduling. For example, when dynamic scheduling between SDM STxMP and sTRP is configured and two sounding reference signal (SRS)-ResourceSet are configured, under non-codebook operation: half of all SRS-Resource in each SRS-ResourceSet are used for PUSCH scheduling when the STxMP is scheduled, and all of SRS-Resource in each SRS-ResourceSet are used for PUSCH scheduling when the sTRP is scheduled.

In an aspect, for SDM STxMP operation, UE 802 can indicate to NW 804 whether UE supports dynamic switching between SDM STxMP and sTRP. This may be performed by signaling the NW 804 of UE capabilities at operation 816. The network receives, from the UE 802, the indication of whether the UE supports dynamic switching between the SDM STxMP, and sTRP. In response, the NW 804 may schedule uplink and downlink communication accordingly at operation 814.

In one aspect, for SDM STxMP operation, UE 802 can indicate to the NW 804 whether UE shares ports between SDM and sTRP if UE supports SDM STxMP and sTRP. The NW 804 receives this indication from the UE 804. If UE shares ports between SDM and sTRP, for codebook operation, UE expects that the total number of SRS ports configured for PUSCH scheduling is the same across both panels (both SRS-ResourceSet) for SDM STxMP scheduling and a single panel (single SRS-ResourceSet) for sTRP scheduling. For nonCodebook operation, UE expects that the total number of SRS resources configured for PUSCH scheduling is the same across both panels (both SRS-ResourceSet) for SDM STxMP scheduling and a single panel (single SRS-ResourceSet) for sTRP scheduling.

For example, UE 802 may, at operation 816, provide an indication of whether the UE shares ports between SDM and sTRP to the NW 804. At operation 814 and operation 810, the NW 804 and UE 802 may operate under the assumption that i) the total number of SRS ports configured for PUSCH scheduling is the same across both panels (both SRS-ResourceSet) for SDM STxMP scheduling and a single panel (single SRS-ResourceSet) for sTRP scheduling, and ii) for nonCodebook operation, the total number of SRS resources configured for PUSCH scheduling is the same across both panels (both SRS-ResourceSet) for SDM STxMP scheduling and a single panel (single SRS-ResourceSet) for sTRP scheduling.

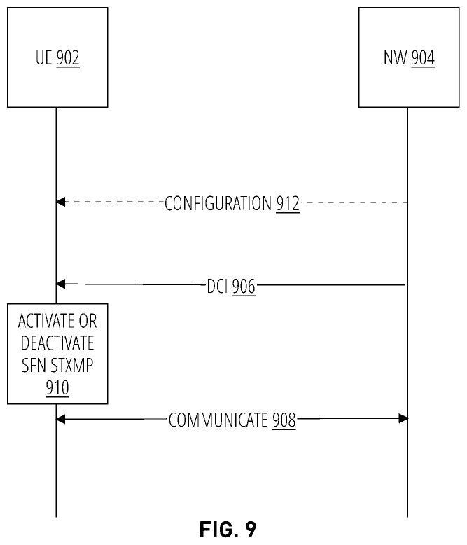

FIG. 9 shows an example diagram illustrating dynamic switching between SFN STxMP and sTRP, in accordance with some embodiments.

The network (NW) 904 may comprise one or more base stations. UE 902 may be associated with or in communication with NW 904. At operation 906, the NW 904 may transmit a downlink control information (DCI) signal to the UE 902. The DCI may comprise various fields for information or instruction that the UE may use to perform various operations. In particular, the DCI may comprise an indication associated with UE operation under simultaneous transmission across multiple panels (STxMP) with single frequency network (SFN). For example, the indication may include a field that, depending on the value, indicates the UE to transition from SFN STxMP mode to sTRP mode, or to transition from sTRP mode to SFN STxMP mode.

At operation 910, the UE 902 may, in response to the indication, transition from SFN STxMP mode to sTRP mode, or transition from sTRP mode to SFN STxMP mode. The NW 904 may provide this signaling at operation 906 to UE 902 dynamically. Similarly, the UE may activate or deactivate SFN STxMP mode dynamically.

At operation 908, the NW 904 and the UE 902 may communicate based on a maximum number of layers associated with the indication provided to the UE 902 through operation 906. For example, the UE 902 may perform uplink communications with NW 904 using a single panel, or two panels, as described and a maximum number of layers, which may be determined based on one or more other factors, as described below. Each layer may refer to an independent data stream.

Configuration operation 912 may include one or more signals from NW 904 to UE 902 to configure one or more settings of the UE (e.g., UL PTRS, or other settings). Configuration operation 912 may include RRC signaling, a higher layer signaling, or other signaling. Configuration operation 912 may occur in time as shown in the example, but may also be provided from the NW to the UE at other times.

In one aspect, when the NW 904 configures the UE 902 with single DCI based SFN STxMP operation (e.g., at operation 906), for the maximum number of PUSCH layers configuration, the UE 902 and NW 904 may operate under one or more of the following restrictive options regarding the number of layers used in communication. In option 1, Lmax,sTRP≤2*Lmax,SFN. In option 2, SFN Lmax,sTRP≥Lmax,SFN. In option 3, Lmax,sTRP=2*Lmax,SFN. In option four, Lmax,sTRP=Lmax,SFN.

Lmax,sTRP refers to the maximum number of layers that may be configured (e.g., at operation 912) for sTRP transmission. Lmax,SFN refers to the maximum number of layers that may be configured (e.g., at operation 912) that is applied to each SRS resource set (panel/TRP) separately during SFN STxMP operation.

For example, the indication provided to the UE 902 (e.g., operation 906) may comprise an instruction for the UE to transition from STxMP (e.g., SFN STxMP) to single transmission and reception point (sTRP) (e.g., at operation 910). The maximum number of layers associated with the indication comprises a maximum number of layers associated with the sTRP (Lmax,sTRP) that is equal to or less than twice a maximum number of layers associated with each individual panel for STxMP (Lmax,SFN).

In another example, the indication comprises an instruction to transition from STxMP (e.g., SFN STxMP) to single transmission and reception point (sTRP). The maximum number of layers associated with the indication comprises a maximum number of layers associated with the sTRP (Lmax,sTRP) that is equal or greater than a maximum number of layers associated with each individual panel for STxMP (Lmax,SFN).

In an aspect, for SFN PTRS port configuration, when NW 904 configures the UE 902 with single DCI based SFN STxMP operation (e.g., at operation 906), for codebook based PUSCH operation, for each panel, (which may correspond to a respective SRS-ResourceSet), NW 904 configures the same coherency mode. For example, NW 904 may configure the coherency mode for every panel as “fullyAndPartialAndNonCoherent” in a first case, or every panel as “partialAndNonCoherent” in a second case, or every panel as “nonCoherent” in a third case. This aspect also extends to SDM STxMP operation.

In an aspect, for SFN PTRS port configuration, when NW 904 configures the UE 902 with single DCI based SFN STxMP operation (e.g., operation 906), and dynamic switching between SFN STxMP and sTRP is configured, for codebook based PUSCH operation, both SFN STxMP and sTRP may be configured with the same coherency mode, i.e., either “fullyAndPartialAndNonCoherent”, or “partialAndNonCoherent” or “nonCoherent”. SFN PTRS port configuration may be performed through signaling (e.g., RRC signaling) from the NW 904 to the UE 902, at operation 912.

In one aspect, when NW 904 configures the UE 902 with single DCI based SFN STxMP operation, NW 904 may freely configure the number of PTRS ports, i.e., maxNrofPorts in PTRS-UplinkConfig is set to either “n1” or “n2” (e.g., through operation 912). For example, the network may configure the UE with a maximum number of ports for uplink phase tracking reference signal (PTRS) that is set to either n1 or n2 in PTRS-uplink configuration, without restriction. As described with respect to FIG. 7, n1 and n2 may be enumerated values that specify respective maximum number values. In this and in other examples, n1 may represent a maximum of ‘one port’ and n2 may represent a maximum of ‘two ports’.

In one aspect, when the NW 904 configures the UE 902 with single DCI based SFN STxMP operation (e.g., operation 906), NW is to configure two port PTRS, such as setting maxNrofPorts in PTRS-UplinkConfig to “n2” (e.g., at operation 912). For example, the network configures the UE with a maximum number of ports for uplink phase tracking reference signal (PTRS) that is set to n2 in PTRS-uplink configuration, but not as n1.

In one aspect, when the NW 904 configures the UE 902 with single DCI based SFN STxMP operation (e.g., at operation 906) and NW configures 2 port UL PTRS (e.g., at operation 912), when dynamic switching between SFN and sTRP is configured, and when gNB schedules sTRP, in terms of the number of ports for UL PTRS, multiple options may be implemented. In a first option, only single port is assumed by the UE 902 and NW 904. In a second option, two port PTRS is assumed by the UE 902 and NW 904. When the network configures the UE with two port uplink (UL) PTRS, and when dynamic switching between SFN and single transmission and reception point (sTRP) is configured, and when the network schedules the sTRP, the network assumes either one port or two ports are used for UL PTRS. This aspect may extend to SDM STxMP as well.

In one aspect, when NW 904 configures the UE 902 with single DCI based SFN STxMP operation (e.g., at operation 906), and NW configures two port UL PTRS (e.g., at operation 912), when dynamic switching between SFN and sTRP is configured, and when gNB schedules sTRP, one port UL PTRS is assumed under one or multiple of the following assumptions: i) the network (gNB) configures full-coherent PUSCH operation for sTRP, i.e., “fullyAndPartialAndNonCoherent”; and ii) the network configures non-coherent PUSCH operation for sTRP, i.e., “nonCoherent” with only single port. For codebook, the maximum number of ports is the number of SRS port for SRS-Resource in SRS-ResourceSet with usage=“codebook”. For non-codebook, the maximum number of ports is the number of SRS-Resource in SRS-ResourceSet with usage=“nonCodebook”.

For example, when the network configures the UE with two port uplink (UL) PTRS, and when dynamic switching between SFN and single transmission and reception point (sTRP) is configured, and when the network schedules the sTRP, the network assumes one port is used for UL PTRS in response to at least one of: i) the network configures full-coherent physical uplink shared channel (PUSCH) operation for sTRP, or ii) the network configures single port non-coherent PUSCH operation for sTRP, wherein for codebook operation, the number of ports is the number of sounding reference signal (SRS) port for SRS-Resource in SRS-ResourceSet with usage set to codebook, and for non-codebook, the number of ports is the number of the SRS-Resource in the SRS-ResourceSet with usage set to nonCodebook.

In one aspect, when the NW 904 configures the UE 902 with single DCI based SFN STxMP operation (e.g., at operation 906) and NW 904 configures two port UL PTRS (e.g., through operation 912), when dynamic switching between SFN and sTRP is configured, and when gNB schedules sTRP (e.g., through operation 906), two port UL PTRS is assumed under one or multiple of the following conditions: the network (e.g., gNB) configures partial-coherent PUSCH operation for sTRP, i.e., “partialAndNonCoherent”; the network configures non-coherent PUSCH operation, i.e., “nonCoherent” for sTRP with more than 1 port. For codebook, the number of ports is equal to the number of SRS ports for SRS-Resource in SRS-ResourceSet with usage=“codebook”. For non-codebook, the number of ports is equal to the number of SRS-Resource in SRS-ResourceSet with usage=“nonCodebook”. Regarding PTRS-DMRS association indication, this signaling field may be used for PUSCH scheduling to indicate which DMRS port should be used for PTS transmission.

For example, when the network configures the UE with two port uplink (UL) PTRS, and when dynamic switching between SDM and single transmission and reception point (sTRP) is configured, and when the network schedules the sTRP, the network assumes two port UL PTRS in response to at least one of: i) the network configures partial-coherent physical uplink shared channel (PUSCH) operation for sTRP, or ii) the network configures non-coherent PUSCH operation for sTRP with more than 1 port, wherein for codebook operation, the number of ports (or layers) is equal to a number of sounding reference signal (SRS) port for SRS-Resource in SRS-ResourceSet with usage set to codebook, and for non-codebook, the number of ports (or layers) is equal to a number of the SRS-Resource in the SRS-ResourceSet with usage set to nonCodebook.

In an aspect, when the NW 904 configures the UE 902 with single DCI based SFN STxMP operation (e.g., at operation 906), in DCI format 0_1 and 0_2, the bitwidth of “PTRS-DMRS association” is 0 under any of the following condition: PTRS-UplinkConfig is not configured and transform precoder is disabled; transform precoder is enable; Lmax,SFN=1 and dynamic switching between SFN STxMP and sTRP is not configured; and/or Lmax,SFN=1 and Lmax,sTRP=1 and dynamic switching between SFN STxMP and sTRP is configured. For example, the network sets a bitwidth of a phase tracking reference signal demodulation reference signal association (PTRS-DMRS association) to zero when a DCI format of the DCI is 0_1 or 0_2, in response to one or more of the following first conditions: PTRS-uplink configuration is not configured and transform precoder is disabled, transform precoder is enabled, a maximum number of layers for SFN is one and dynamic switching between SFN STxMP and sTRP is not configured, or a maximum number of layers for SFN and sTRP are equal to one and dynamic switching between SFN STxMP and sTRP is configured. This may be referred to as a first scenario.

In an aspect, when the NW 904 configures the UE 902 with single DCI based SFN STxMP operation (e.g., at operation 906), in DCI format 0_1 and 0_2, the bitwidth of “PTRS-DMRS association” is 1 when PTRS-UplinkConfig is configured and transform precoder is disabled (e.g., through operation 912), and under any of the following condition: Lmax,SFN=1 and Lmax,sTRP=2 and full-coherent operation is configured for sTRP and dynamic switching between SFN STxMP and sTRP is configured. For example, the network sets the bitwidth of the PTRS-DMRS association to one when the DCI format of the DCI is 0_1 or 0_2 and when the PTRS-uplink configuration is configured and the transform precoder is disabled, and in response to a second condition which includes the maximum number of layers for SFN being equal to one, and the maximum number of layers for sTRP being equal to two, and a coherent operation being configured for sTRP and the dynamic switching between SFN STxMP and sTRP being configured. This may be referred to as a second scenario.

In an aspect, when NW 904 configures the UE 902 with single DCI based SFN STxMP operation (at operation 906), in DCI format 0_1 and 0_2, the bitwidth of “PTRS-DMRS association” is 2 under either of the following conditions: the conditions under the first scenario are not satisfied, or the conditions under the first scenario and the second scenario are not satisfied. For example, the network sets a bitwidth of the PTRS-DMRS association to two when the DCI format of the DCI is 0_1 or 0_2 in response to none of the first conditions and none of the second condition being satisfied.

In an aspect, when NW 904 configures the UE 902 with single DCI based SFN STxMP operation (e.g., operation 906), in DCI format 0_1 and 0_2, the bitwidth of “PTRS-DMRS association” is 2 and 2 port PTRS is configured (e.g., operation 912), when SFN STxMP is scheduled, interpretation of “PTRS-DMRS association” field by the UE may be defined as follows: i) PTRS port 0 is associated with the DMRS ports associated with the first SRS resource set—DMRS ports associated with the first TPMI or SRI; and/or ii) PTRS port 1 is associated with the DMRS ports associated with the second SRS resource set—DMRS ports associated with the second TPMI or SRI. For example, when a DCI format of the DCI is 0_1 or 0_2, and when a bitwidth of PTRS-DMRS association is two, and when two port PTRS is configured, and when SFN STxMP is scheduled, the network associates a PTRS port zero with first DMRS ports that are associated with a first SRS resource set; and the network associates a PTRS port one with second DMRS ports that are associated a second SRS resource set.

In an aspect, when NW 904 configures the UE 902 with single DCI based SFN STxMP operation (e.g., operation 906), in DCI format 0_1 and 0_2, the bitwidth of “PTRS-DMRS association” is 2 and 2 port PTRS is configured, if Lmax,SFN=1, when SFN STxMP is scheduled, one option is that UE is not expected to be indicated “PTRS-DMRS association” other than “00”, and a second option is that regardless of what value is indicated by “PTRS-DMRS association”, UE 902 will always assume “00” for the association. For example, when a DCI format of DCI is 0_1 or 0_2, and when a bitwidth of PTRS-DMRS association is two, and when two port PTRS is configured, and when SFN STxMP is scheduled, in response to a maximum number of layers of SFN is equal to one, the network indicates PTRS-DMRS association as ‘00’, or the UE operates under an assumption that PTRS-DMRS association is equal to ‘00’. See Table 1 and Table 2 above for PTRS-DMRS association mapping.

In an aspect, when NW 904 configures the UE 902 with single DCI based SFN STxMP operation (e.g., at operation 906), in DCI format 0_1 and 0_2, the bitwidth of “PTRS-DMRS association” is two and two port PTRS is configured, when sTRP is scheduled, interpretation of “PTRS-DMRS association” field by the UE and NW is as follows: i) PTRS port 0 is associated with DMRS port associated with UL layers which are transmitted with PUSCH antenna port 1000 and PUSCH antenna port 1002 (same as SDM), and/or ii) PTRS port 1 is associated with DMRS port associated with UL layers which are transmitted with PUSCH antenna port 1001 and PUSCH antenna port 1003. For example, when a DCI format of DCI is 0_1 or 0_2, and when a bitwidth of PTRS-DMRS association is two, and when two port PTRS is configured, and when sTRP is scheduled, the network associates PTRS port 0 with a first DMRS port that is associated with uplink (UL) layers which are transmitted with physical uplink shared channel (PUSCH) antenna port 1000 and PUSCH antenna port 1002, and the network associates PTRS port 1 with a second DMRS port that is associated with UL layers which are transmitted with PUSCH antenna port 1001 and PUSCH antenna port 1003.

In an aspect, when NW 904 configures the UE 902 with single DCI based SFN STxMP operation, in DCI format 0_1 and 0_2, the bitwidth of “PTRS-DMRS association” is two and two port PTRS is configured, when sTRP is scheduled, and when coherent transmission is configured for sTRP: the UE 902 and NW 904 may operate as if configured as single port PTRS, regardless of how PTRS is configured (e.g., through operation 912). The interpretation of the “PTRS-DMRS association” follows Table 1 provided above.

In an aspect, when NW 904 configures the UE 902 with single DCI based SFN STxMP operation (e.g., operation 906), in DCI format 0_1 and 0_2, two “PTRS-DMRS association” fields are supported and included in the DCI (e.g., at operation 906) by the NW 904. Additionally, when SFN STxMP is scheduled (e.g., through operations 906 and 910), both “PTRS-DMRS association” fields are used. Additionally, or alternatively, when sTRP is scheduled (e.g., through operations 906 and 910), only the first “PTRS-DMRS association” field is used by the UE, the second “PTRS-DMRS association” field is ignored by the UE. For example, when a DCI format of DCI is 0_1 or 0_2, the network includes two PTRS-DMRS association fields in the DCI, wherein when the network schedules SFN STxMP, both of the PTRS-DMRS association fields are used, and when the network schedules sTRP, a first PTRS-DMRS association field is used and a second PTRS-DMRS association field is not used. This aspect may also apply in the case of SDM STxMP.

In an aspect, when NW 904 configures the UE 902 with single DCI based SFN STxMP operation (e.g., operation 906), in DCI format 0_1 and 0_2, when two “PTRS-DMRS association” fields are supported/included in the DCI. For SFN STxMP scheduling, the UE may treat the first “PTRS-DMRS association” field as being associated with the first panel (e.g., SRS resource set), or the first transcoder precoder matrix indicator (TPMI) or SRS resource indicator (SRI); and/or the second “PTRS-DMRS association” field is associated with the second panel, i.e., SRS resource set, in other words, the second TPMI or SRI. This aspect may also apply in the case of SDM STxMP.

For example, when a DCI format of DCI is 0_1 or 0_2, and when the two PTRS-DMRS association fields are included in the DCI, the first PTRS-DMRS association field is associated with a first panel, and the second PTRS-DMRS association field is associated with a second panel. These panels may be the panels used by UE 904 to communicate with NW 904 at operation 908. The panels may correspond to panels described in FIG. 7.

In an aspect, (SFN 2.10), when NW 904 configures the UE 902 with single DCI based SFN STxMP operation (e.g., at operation 906), for non-Codebook PUSCH of SFN scheme, the UE ignores the configuration of “ptrs-PortIndex”, e.g., as defined in an SRS resource or SRS resource set.

It should be understood that the aspects described in the present disclosure are not exclusive of each other and may be combined with each other unless logically incompatible as understood by one skilled in the art.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

A baseband processor (also known as baseband radio processor, BP, or BBP) is a device (a chip or part of a chip) in a network interface that manages radio functions, such as communicating (e.g., TX and RX) over an antenna.

An article of manufacture may be used to store program code. An article of manufacture that stores program code may be embodied as, but is not limited to, one or more memories (e.g., one or more flash memories, random access memories (static, dynamic, or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “transmitting”, “sending”, “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary aspects of the present invention. One skilled in the art will readily recognize from such discussion, the accompanying drawings and the claims that various modifications can be made without departing from the spirit and scope of the invention.

1. A method, performed by a network in communication with a user equipment (UE), comprising:
transmitting, by the network, a downlink control information (DCI) signal to the UE, the DCI signal comprising an indication associated with UE operation under simultaneous transmission across multiple panels (STxMP) with spatial division multiplexing (SDM); and
communicating with the UE based on a maximum number of layers associated with the indication.

2-21. (canceled)

22. A method, performed by user equipment (UE) that is in communication with a network, comprising:
receiving, by the UE, a downlink control information (DCI) signal from the network, the DCI comprising an indication associated with UE operation under simultaneous transmission across multiple panels (STxMP) with space division multiplexing (SDM); and
communicating with the network based on a maximum number of layers associated with the indication.

23. The method of claim 22, wherein the indication comprises an instruction to transition from STxMP to single transmission and reception point (sTRP); and wherein the maximum number of layers associated with the indication comprises a maximum number of layers associated with the sTRP that is equal to or less than with twice a maximum number of layers associated with each individual panel for STxMP.

24. The method of claim 22, wherein the indication comprises an instruction to transition from STxMP to single transmission and reception point (sTRP); and wherein the maximum number of layers associated with the indication comprises a maximum number of layers associated with the sTRP that is equal to a maximum number of layers associated with each individual panel for STxMP.

25. The method of claim 22, wherein the indication comprises an instruction to transition from single transmission and reception point (sTRP) to STxMP; and wherein the maximum number of layers associated with the indication comprises a maximum number of layers associated with the STxMP that is less than or equal to a maximum number of layers used with the sTRP.

26. The method of claim 22, wherein the network configures the UE with a maximum number of ports for uplink phase tracking reference signal (PTRS) that is set to n2 in PTRS-uplink configuration.

27. (canceled)

28. The method of claim 26, wherein when dynamic switching between SDM and single transmission and reception point (sTRP) is configured, and when the network schedules the sTRP, the network operates under an assumption that only a single port is used for uplink (UL) PTRS.

29. The method of claim 26, wherein when dynamic switching between SDM and single transmission and reception point (sTRP) is configured, and when the network schedules the sTRP, the network operates under an assumption that two port are used for uplink (UL) PTRS.

30. The method of claim 22, wherein when the network configures the UE with two port uplink (UL) PTRS, and when dynamic switching between SDM and single transmission and reception point (sTRP) is configured, and when the network schedules the sTRP, the network assumes one port UL PTRS in response to at least one of: i) the network configures full-coherent physical uplink shared channel (PUSCH) operation for sTRP, or ii) the network configures non-coherent PUSCH operation for sTRP with a single port, wherein for codebook operation, the number of ports is the number of sounding reference signal (SRS) port for SRS-Resource in SRS-ResourceSet with usage set to codebook, and for non-codebook, the number of ports is equal to a number of SRS-Resource in the SRS-ResourceSet with usage set to nonCodebook.

31. The method of claim 22, wherein when the network configures the UE with two port uplink (UL) PTRS, and when dynamic switching between SDM and single transmission and reception point (sTRP) is configured, and when the network schedules the sTRP, the network assumes two port UL PTRS in response to at least one of: i) the network configures partial-coherent physical uplink shared channel (PUSCH) operation for sTRP; or ii) the network configures non-coherent PUSCH operation for sTRP with more than one port, wherein for codebook operation, the number of ports is equal to a number of sounding reference signal (SRS) port for SRS-Resource in SRS-ResourceSet with usage set to codebook, and for non-codebook, the number of ports is equal to a number of SRS-Resource in the SRS-ResourceSet with usage set to nonCodebook.

32. The method of claim 22, wherein the network sets a bitwidth of a phase tracking reference signal demodulation reference signal association (PTRS-DMRS association) to zero when a DCI format of the DCI is 0_1 or 0_2, in response to one or more of the following first conditions: PTRS-uplink configuration is not configured and transform precoder is disabled, transform precoder is enabled, a maximum number of layers for SDM is one and dynamic switching between SDM STxMP and sTRP is not configured, or a maximum number of layers for SDM and sTRP are equal to one and dynamic switching between SDM STxMP and sTRP is configured.

33. The method of claim 32, wherein the network sets the bitwidth of the PTRS-DMRS association to one when the DCI format of the DCI is 0_1 or 0_2 and when the PTRS-uplink configuration is configured and the transform precoder is disabled, and in response to a second condition which includes the maximum number of layers for SDM being equal to one, and the maximum number of layers for sTRP being equal to two, and the coherent operation being configured for sTRP and the dynamic switching between SDM STxMP and sTRP being configured.

34. The method of claim 33, wherein the network sets a bitwidth of the PTRS-DMRS association to two when the DCI format of the DCI is 0_1 or 0_2 in response the first conditions and the second condition not being satisfied.

35. The method of claim 22, wherein when a DCI format of DCI is 0_1 or 02, and when a bitwidth of PTRS-DMRS association is two, and when two port PTRS is configured, and when SDM STxMP is scheduled, the network associates a PTRS port zero with first DMRS ports that are associated with a first SRS resource set; and the network associates a PTRS port one with second DMRS ports that are associated a second SRS resource set.

36. The method of claim 22, wherein when a DCI format of DCI is 0_1 or 02, and when a bitwidth of PTRS-DMRS association is two, and when two port PTRS is configured, and when SDM STxMP is scheduled, in response to a maximum number of layers of SDM is equal to one, the network indicates PTRS-DMRS association as ‘00’, or the UE operates under an assumption that PTRS-DMRS association is equal to ‘00’.

37. The method of claim 22, wherein when a DCI format of DCI is 0_1 or 02, and when a bitwidth of PTRS-DMRS association is two, and when two port PTRS is configured, and when sTRP is scheduled, the network associates PTRS port 0 with a first DMRS port that is associated with uplink (UL) layers which are transmitted with physical uplink shared channel (PUSCH) antenna port 1000 and PUSCH antenna port 1002, and the network associates PTRS port 1 with a second DMRS port that is associated with UL layers which are transmitted with PUSCH antenna port 1001 and PUSCH antenna port 1003.

38. The method of claim 22, wherein when a DCI format of DCI is 0_1 or 02, and when a bitwidth of PTRS-DMRS association is two, and when two port PTRS is configured, and when sTRP is scheduled, and when coherent transmission is configured for sTRP, the network operates under an assumption of single port PTRS operation, and PTRS-DMRS association for UL PTRS port zero is: zero for a first scheduled DMRS port, one for a second scheduled DMRS port, two for a third scheduled DMRS port, and three for a fourth scheduled DMRS port.

39. The method of claim 22, wherein when dynamic scheduling between SDM STxMP and sTRP is configured and two sounding reference signal (SRS)-ResourceSet are configured, under codebook operation: half of all SRS ports in each SRS-Resource in the SRS-ResourceSet are used for PUSCH scheduling when STxMP is scheduled, and all of the SRS ports in each SRS-Resource in the SRS-ResourceSet are used for PUSCH scheduling when sTRP is scheduled.

40. The method of claim 22, wherein when dynamic scheduling between SDM STxMP and sTRP is configured and two sounding reference signal (SRS)-ResourceSet are configured, under non-codebook operation: half of all SRS-Resource in each SRS-ResourceSet are used for PUSCH scheduling when the STxMP is scheduled, and all of SRS-Resource in each SRS-ResourceSet are used for PUSCH scheduling when the sTRP is scheduled.

41-82. (canceled)

83. A user equipment (UE), comprising:
a memory configured to store one or more instructions; and
one or more processors configured to, when executing the one or more instructions, cause the UE to:
receive, by the UE, a downlink control information (DCI) signal from a network, the DCI comprising an indication associated with UE operation under simultaneous transmission across multiple panels (STxMP) with space division multiplexing (SDM); and
communicate with the network based on a maximum number of layers associated with the indication.
